(19) United States
(12) Patent Application Publication
(10) Pub. No.: US 2024/0001843 A1
(43) Pub. Date: Jan. 4, 2024

(54) DISPLAY DEVICE

(71) Applicant: NIPPON SEIKI CO., LTD., Niigata (JP)

(72) Inventor: Shun Yamaguchi, Niigata (JP)

(21) Appl. No.: 18/341,226

(22) Filed: Jun. 26, 2023

(30) Foreign Application Priority Data
Jul. 4, 2022 (JP) 2022-107422

(51) Int. Cl. B60Q 9/00

(52) U.S. Cl. CPC B60Q 9/00

(57) ABSTRACT

To provide a display device enabled to convey information appropriately. A display device according to the present embodiment includes a display that displays, in a display area, a warning indicator for notifying a viewer of a warning object located outside a vehicle and an attention-grabbing indicator for drawing attention of the viewer to the warning indicator; and a display controller that controls and directs, upon detection of the warning object, the display to display the warning indicator in the display area at a warning position corresponding to the warning object and to display the attention-grabbing indicator in such a manner that the attention-grabbing indicator advances from a position other than the warning position toward the warning position.

### TECHNICAL FIELD

The present disclosure relates to a display device for a vehicle.

### BACKGROUND ART

A conventionally known technology uses a display device such as a head-up display (HUD) to encourage a viewer such as a vehicle driver to look ahead when an object to be notified to the viewer is detected in front of the vehicle.

### PRIOR ART DOCUMENT

### Patent Document

Patent Document 1: Japanese Unexamined Patent Application Publication No. 2010-155496

### SUMMARY OF INVENTION

### Technical Problem

Nowadays, display devices have become capable of displaying information in various ways, which has led to the use of various areas in vehicles as display areas. For example, a narrow area can be used as a display area of a display device, such as a light-shielding section (so-called black ceramic band) formed along a lower edge of a windshield extending in a left-right direction.

Note here that in the case of a display device that displays various information at different locations or in the case of a display device that has a single but relatively small display area, for example, a viewer can fail to notice the information, and thus the display device can fail to convey the information appropriately.

The present disclosure was achieved in consideration of the above-described circumstances, and an objective thereof is to provide a display device enabled to convey information appropriately.

### Solution to Problem

In order to solve the above-described problems, a display device according to the present disclosure includes: a display that displays, in a display area, a warning indicator for notifying a viewer of a warning object located outside a vehicle and an attention-grabbing indicator for drawing attention of the viewer to the warning indicator; and a display controller that controls and directs, upon detection of the warning object, the display to display the warning indicator in the display area at a warning position corresponding to the warning object and to display the attention-grabbing indicator in such a manner that the attention-grabbing indicator advances from a position other than the warning position toward the warning position.

### Advantageous Effects of Invention

The display device according to the present disclosure is enabled to convey information appropriately.

### BRIEF DESCRIPTION OF DRAWINGS

FIG. 1 is an explanatory diagram illustrating an example of a system configuration of a display device according to an embodiment.

FIG. 2 is an explanatory diagram illustrating an example of mounting the display device in a vehicle.

FIG. 3 is a flowchart for describing warning display processing to be performed by the display device according to the present embodiment.

FIG. 4 is a diagram illustrating time transition of a warning indicator and an attention-grabbing indicator displayed when a warning object is detected.

FIG. 5 is a diagram illustrating the time transition of the warning indicator and the attention-grabbing indicator displayed when the warning object is detected.

FIG. 6 is a diagram illustrating the time transition of the warning indicator and the attention-grabbing indicator displayed when the warning object is detected.

FIG. 7 is a diagram illustrating the time transition of the warning indicator and the attention-grabbing indicator displayed when the warning object is detected.

FIG. 8 is a diagram illustrating time transition of the warning indicator and the attention-grabbing indicator in a case where the distance between the vehicle and a pedestrian changes.

FIG. 9 is a diagram illustrating the time transition of the warning indicator and the attention-grabbing indicator in the case where the distance between the vehicle and the pedestrian changes.

FIG. 10 is a diagram illustrating the time transition of the warning indicator and the attention-grabbing indicator in the case where the distance between the vehicle and the pedestrian changes.

FIG. 11 is a diagram illustrating time transition of the warning indicator and the attention-grabbing indicator in a case where the distance between the vehicle and a bicycle changes.

FIG. 12 is a diagram illustrating the time transition of the warning indicator and the attention-grabbing indicator in the case where the distance between the vehicle and the bicycle changes.

FIG. 13 is a diagram illustrating the time transition of the warning indicator and the attention-grabbing indicator in the case where the distance between the vehicle and the bicycle changes.

FIG. 14 is a diagram illustrating time transition of the warning indicator in a case where the traveling direction of a warning object changes.

FIG. 15 is a diagram illustrating the time transition of the warning indicator in the case where the traveling direction of the warning object changes.

FIG. 16 is a diagram illustrating the time transition of the warning indicator in the case where the traveling direction of the warning object changes.

FIG. 17 is a diagram illustrating time transition of the warning indicator in a case where the warning indicator is displayed with a gradient.

FIG. 18 is a diagram illustrating the time transition of the warning indicator in the case where the warning indicator is displayed with a gradient.

FIG. 19 is a diagram illustrating a display device according to another embodiment of the present disclosure.

FIG. 20 is a diagram illustrating a display area formed by the display device.

FIG. 21 is a diagram illustrating examples of a warning indicator and an attention-grabbing indicator displayed.

### DESCRIPTION OF EMBODIMENTS

The following describes a display device according to an embodiment of the present disclosure on the basis of the accompanying drawings. The display device according to the present disclosure is, for example, applicable to display devices for conveying information to viewers such as drivers of automobiles, motorcycles, ships, agricultural machinery, and construction machinery (vehicles). The present embodiment is described using, as an example, a display device that is mounted in an automobile, which is an example of a vehicle, and displays desired information based on, for example, various information obtained from the automobile.

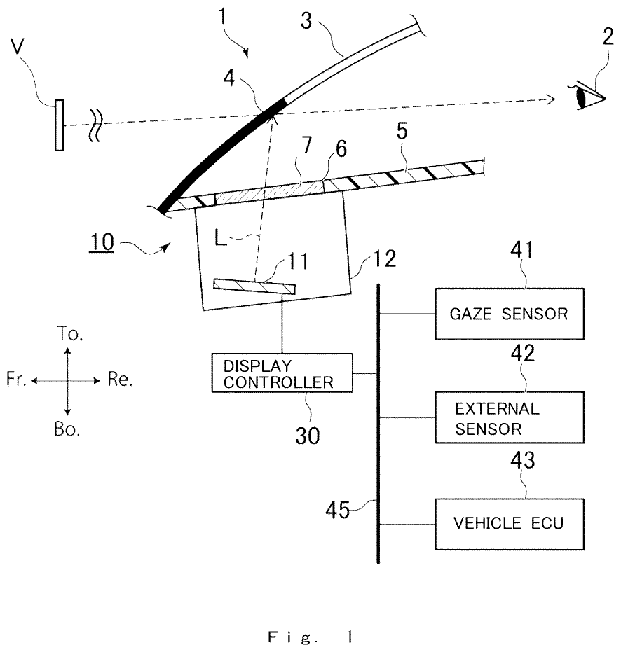

FIG. 1 is an explanatory diagram illustrating an example of a system configuration of a display device 10 according to the present embodiment.

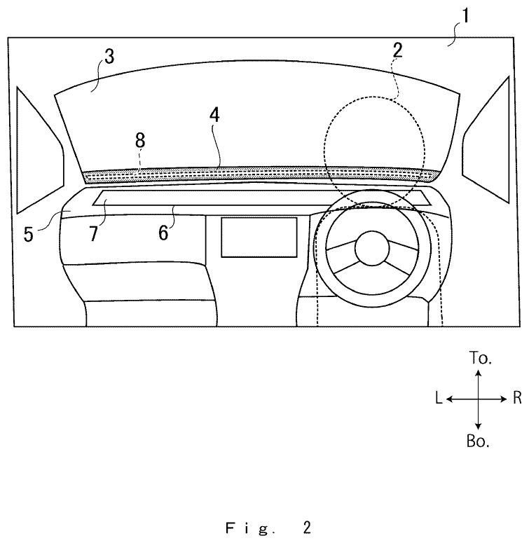

FIG. 2 is an explanatory diagram illustrating an example of mounting the display device 10 in a vehicle 1.

In the following description, “Front”, “Back”, “Top”, “Bottom”, “Right” and “Left” follow the definitions “Fr.”, “Re.”, “To.”, “Bo.”, “R” and “L” in FIGS. 1 and 2.

The display device 10 is mounted in the vehicle 1 and housed in an instrument panel 5 of the vehicle 1. The instrument panel 5 has an opening 6 formed to extend in the left-right direction as shown in FIG. 2. The display device 10 is disposed inside the opening 6. The opening 6 is covered by a protective cover 7 to prevent a driver 2 from seeing the inside thereof and to prevent dust from entering the inside. The protective cover 7 is, for example, a permeable diffuser plate having a line-shaped (band-shaped) design printed in black on a front surface or a back surface of a base material thereof, not shown. The display device 10 uses an area within a light-shielding section 4 formed on a windshield 3 as a display area 8 to display desired information. The light-shielding section 4 is disposed between pillars (window pillars) extending in the top-bottom direction at left and right ends of the windshield 3, and is in a line shape (band shape) along a lower edge of the windshield 3. The display area 8 is formed along a line connecting left and right ends of the light-shielding section 4 to match the range of the light-shielding section 4. The display area 8 is elongate in the left-right direction and has a line shape (band shape) that is narrow in the top-bottom direction.

The display device 10 has an LED unit 11 (display) and a display controller 30.

The LED unit 11 has a plurality of light emitting diodes (LEDs) as light sources and an LED driver. The LEDs have three colors, i.e., red, green, and blue (RGB), and produce and emit display light L. The plurality of LEDs are arranged in the left-right direction, and it is possible to form desired shapes (designs) by turning on and off different combinations of LEDs. The LED driver controls luminance and turning on or off of each LED based on instructions from the display controller 30. It should be noted that the display controller 30 may double as the LED driver.

The LED unit 11 displays and conveys various information within the display area 8 shown in FIG. 2 through combinations of LEDs, with some LEDs turned on and others turned off, as well as colors. The LED unit 11 in the present embodiment conveys, in the line-shaped display area 8, information to the driver 2 by displaying the information in an intuitively recognizable manner using combinations of the width of lit LEDs in the left-right direction and colors, rather than letters or symbols.

A housing 12 houses the LED unit 11. The housing 12 has an opening for emitting the display light L emitted from the LEDs out of the housing 12. This opening is covered by the protective cover 7 as well as the opening 6 of the instrument panel 5 described above. The display light L emitted through the protective cover 7 illuminates the light-shielding section 4 (projection member) of the windshield 3 of the vehicle 1. The light-shielding section 4 is made from, for example, black ceramics and has a light-shielding color such as black. The light-shielding section 4 is formed, for example, to prevent sunlight-induced deterioration of an adhesive fixing the windshield 3 to the vehicle 1, to hide the adhesive, and to improve the design. The driver 2 (viewer) of the vehicle 1 sees, as a virtual image V, the display light L that has been reflected. In other words, the driver 2 sees the display light L as the virtual image V in front of the light-shielding section 4 (in front of the vehicle 1 or the windshield 3).

The display controller 30 has, for example, a CPU, ROM, and RAM, and executes predetermined arithmetic processing in accordance with a program written in the ROM. Specifically, the display controller 30 controls the LED unit 11 based on, for example, information obtained from a vehicle ECU 43 of the vehicle 1 described below to display desired information. Details of the control by the display controller 30 are described below.

In addition to the display device 10, the vehicle 1 has a gaze sensor 41, an external sensor 42, and the vehicle electronic control unit (ECU) 43. The display controller 30, the gaze sensor 41, the external sensor 42, and the vehicle ECU 43 are connected, for example, via a controller area network (CAN) bus 45.

The gaze sensor 41 includes, for example, a camera that captures an image of the driver 2 and an image processor, and detects the gaze (viewing position and gazing direction) of the driver 2. It should be noted that the gaze sensor 41 may be disposed on the display device 10 side rather than on the vehicle 1 side. For example, the gaze sensor 41 may be disposed in the housing 12 of the display device 10.

The external sensor 42 detects and identifies objects such as people, structures, and other vehicles present in external surroundings to the top, bottom, front, back, left, and right of the vehicle 1 (locations around the vehicle 1) and positions of the objects. Examples of the external sensor 42 include: a stereo camera that captures images of the scenery around the vehicle 1; a range-finding sensor such as a laser imaging detection and ranging (LIDAR) sensor that measures the distance from the vehicle 1 to an object; a sonar, an ultrasonic sensor, and a millimeter-wave radar that detect objects located around the vehicle 1.

The vehicle ECU 43 obtains vehicle information necessary for driving the vehicle 1, such as vehicle speed and engine rotation speed, from various sensors provided on the vehicle 1, and controls operation of the vehicle 1.

The following describes warning display processing to be performed by the display device 10. As described above, the display device 10 according to the present embodiment uses an area within the light-shielding section 4 as the display area 8, and provides notification in the line-shaped display area 8 that is elongate in the left-right direction and considerably short in the top-bottom direction compared to the length in the left-right direction. Specifically, when the external sensor 42 detects a warning object located outside the vehicle 1, the display device 10 displays a warning indicator for notifying the driver 2 of the presence of the warning object. Examples of warning objects include pedestrians, bicycles, fallen objects on the road, and any other objects located in front of the vehicle 1 and posing a safety hazard to driving. The warning indicator is, for example, displayed with a predetermined width in a warning color such as red in the display area 8 at a position (hereinafter referred to as “warning position”) in the left-right direction corresponding to the position of the warning object in the left-right direction. The warning position refers to, for example, a location on the display area 8 that is on a line connecting the viewpoint of the driver 2 and the warning object.

Note here that the display device 10, which displays the warning indicator at the warning position corresponding to the position of the warning object, is only capable of conveying information to the driver 2 by emitting predetermined colors of light (by lighting LEDs) at the position of the warning object. In other words, the warning indicator is not letters, symbols, or other information that carry meanings, and the driver 2 can fail to notice the warning indicator. The display device 10 according to the present embodiment therefore displays an attention-grabbing indicator when displaying the warning indicator to appropriately notify the driver 2 of the warning. The following describes the warning display processing to be performed by the display device 10 in detail.

FIG. 3 is a flowchart for describing the warning display processing to be performed by the display device 10 according to the present embodiment. The warning display processing is performed, for example, when a door of the vehicle 1 is opened or when a starting switch (for example, ignition switch) is turned on.

In Step S1, the display controller 30 determines whether or not a warning object has been detected. The display controller 30 determines the detection of a warning object by obtaining a detection result from the external sensor 42. Upon determining that no warning object has been detected (NO in Step S1), the display controller 30 waits until determining that a warning object has been detected.

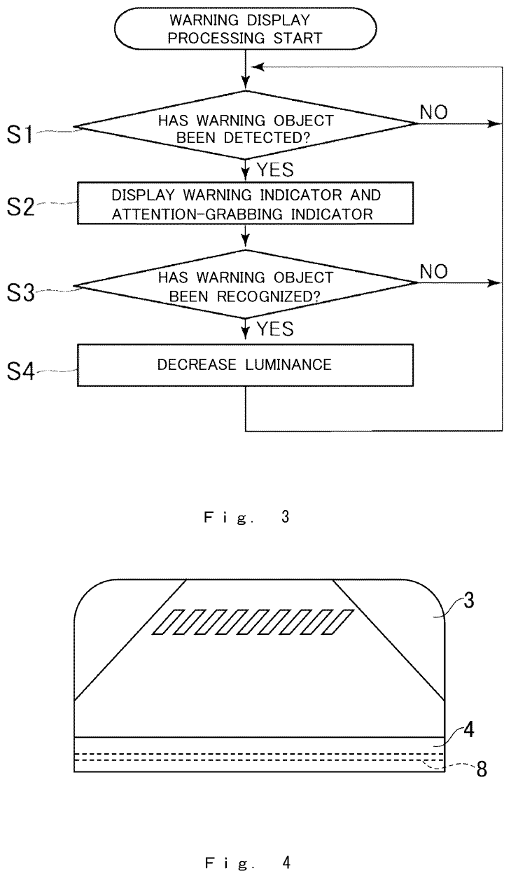

On the other hand, upon determining that a warning object has been detected (YES in Step S1), the display controller 30 displays a warning indicator and an attention-grabbing indicator in Step S2. The attention-grabbing indicator is displayed, for example, in a different color from the warning indicator (for example, in yellow in a case where the warning indicator is displayed in red) to draw the attention of the driver 2 to the warning indicator. Note here that, FIGS. 4 to 7 are diagrams illustrating time transition of a warning indicator 51 and an attention-grabbing indicator 52 displayed when a warning object 50 is detected.

The display controller 30 displays the warning indicator 51 as shown in FIGS. 5 to 7 in the display area 8, in which nothing is displayed before the warning object 50 is detected (NO in Step S1) as shown in FIG. 4. Specifically, the display controller 30 displays the warning indicator 51 in the display area 8 at a warning position corresponding to the warning object 50. The warning position refers to a location in the display area 8 in terms of the left-right direction relative to the position of the warning object 50 in the display area 8 in terms of the left-right direction. The display controller 30 also displays the attention-grabbing indicator 52 in such a manner that the attention-grabbing indicator 52 advances from a position other than the warning position toward the warning position.

Specifically, as shown in FIG. 5, the display controller 30 determines, as the warning position, a location in the display area 8 that substantially overlaps the position of the warning object 50 in the forward field of view of the driver 2 in the left-right direction, and displays the warning indicator 51 at the warning position. Furthermore, the display controller 30 displays the attention-grabbing indicator 52 in such a manner that the attention-grabbing indicator 52 advances along a line formed by the display area 8. For example, the display controller 30 causes the attention-grabbing indicator 52 to advance toward the warning indicator 51 by increasing the width thereof in the left-right direction with time.

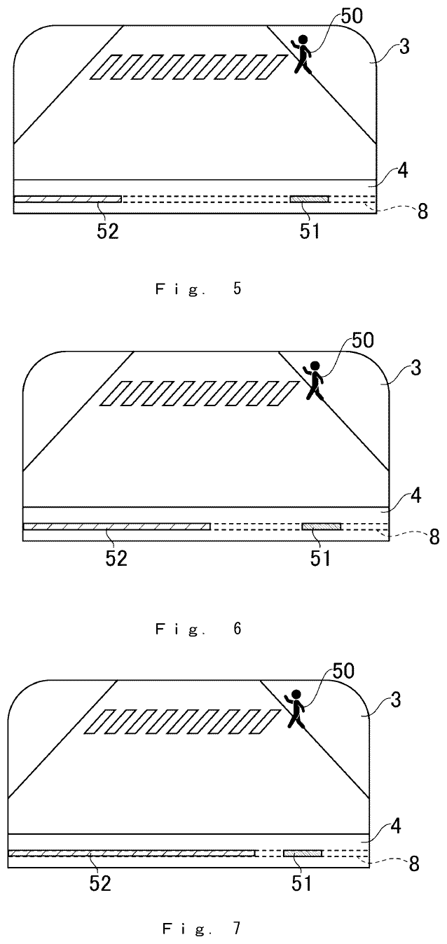

Specifically, immediately after starting the display of the attention-grabbing indicator 52, the display controller 30 is displaying the attention-grabbing indicator 52 that has a first width spanning from a left end thereof coinciding with a left end of the display area 8 as shown in FIG. 5. After a predetermined period of time has elapsed, the display controller 30 transitions the attention-grabbing indicator 52 in such a manner that the attention-grabbing indicator 52 has a second width wider than the first width by moving a right end of the attention-grabbing indicator 52 toward a right end of the display area 8 as shown in FIG. 6. After the predetermined period of time has further elapsed, the display controller 30 transitions the attention-grabbing indicator 52 in such a manner that the attention-grabbing indicator 52 has a third width wider than the second width by further moving the right end of the attention-grabbing indicator 52 toward the right end of the display area 8 as shown in FIG. 7.

It should be noted that the display controller 30 may cause the attention-grabbing indicator 52 to advance by, instead of increasing the width along the line, gradually moving the attention-grabbing indicator 52 toward the warning indicator while maintaining the width of the attention-grabbing indicator 52 unchanged over time. That is, “causing the attention-grabbing indicator 52 to advance” includes extending the width of the attention-grabbing indicator 52 toward the warning indicator 51 (moving the right end of the attention-grabbing indicator 52 toward the warning indicator 51) and moving the attention-grabbing indicator 52 having a fixed width itself toward the warning indicator 51. The advancing direction of the attention-grabbing indicator 52 is determined according to the position of the warning indicator 51. That is, in a case where the warning indicator 51 is located to the right of the center of the display area 8, the attention-grabbing indicator 52 advances from left to right. In a case where the warning indicator 51 is located to the left of the center of the display area 8, the attention-grabbing indicator 52 advances from right to left. The starting point of the advancing attention-grabbing indicator 52 is not limited to the right end or the left end of the display area 8.

By causing the attention-grabbing indicator 52 to advance toward the warning indicator 51 as described above, the display controller 30 can draw the attention of the driver 2 to the warning indicator 51 displayed in the display area 8 at the position corresponding to the warning object 50. As a result, the display controller 30 can make the driver 2 recognize the warning object 50.

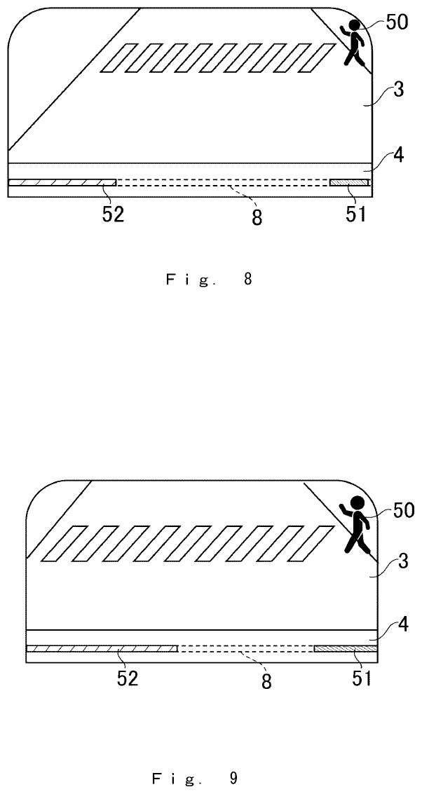

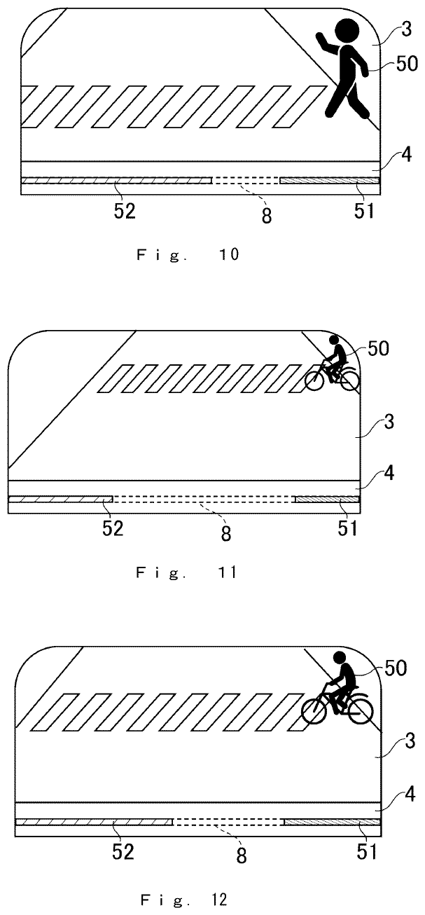

FIGS. 8 to 10 are diagrams illustrating time transition of the warning indicator 51 and the attention-grabbing indicator 52 in a case where the distance between the vehicle 1 and a pedestrian changes. The display controller 30 varies the width of the warning indicator 51 in the left-right direction (width in a predetermined direction) according to the distance between the vehicle 1 and the warning object 50. Specifically, the display controller 30 decreases the width of the warning indicator 51 with an increase in the distance (as the warning object gets farther) and a decrease in the warning level, and increases the width of the warning indicator 51 with a decrease in the distance (as the warning object gets closer) and an increase in the warning level. For example, as shown in FIGS. 8 to 10, the display controller 30 gradually increases the width of the warning indicator 51 in the left-right direction as the distance between the vehicle 1 and the pedestrian, which is the warning object 50, gradually decreases. The above-described configuration allows the driver 2 to intuitively recognize the distance between the vehicle 1 and the warning object 50 from visual information, which is the width of the warning indicator 51.

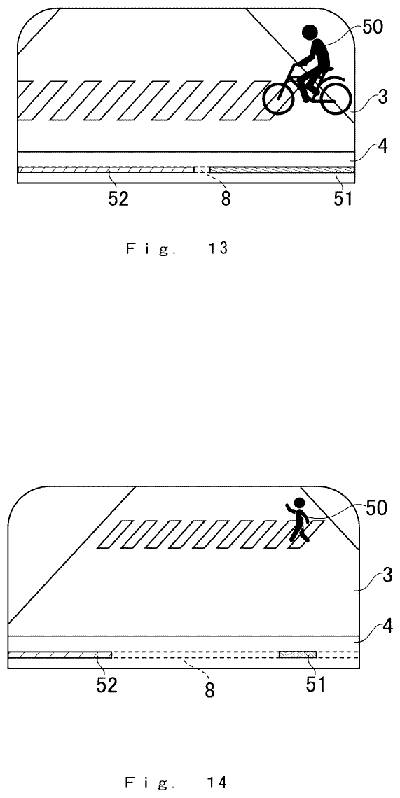

The display controller 30 may also vary the mode of the warning indicator 51 according to the type of the warning object 50. FIGS. 11 to 13 are diagrams illustrating time transition of the warning indicator 51 and the attention-grabbing indicator 52 in a case where the distance between the vehicle 1 and a bicycle changes. The display controller 30 displays, for example, the warning indicator 51 with a wider width in the case where the warning object 50 is a bicycle than in the case where the warning object 50 is a pedestrian to vary the mode. For example, the width of the warning indicator 51 in FIGS. 8 to 10 showing the case where the warning object 50 is a pedestrian is smaller than the width of the warning indicator 51 in FIGS. 11 to 13 showing the case where the warning object 50 is a bicycle. It should be noted that the display controller 30 may use other properties, such as color or luminance, as well as the width of the warning indicator 51 to vary the mode according to the type of the warning object 50.

The above-described configuration allows the driver 2 to intuitively recognize the type of the warning object 50 based on the difference in the display mode including the width of the warning indicator 51.

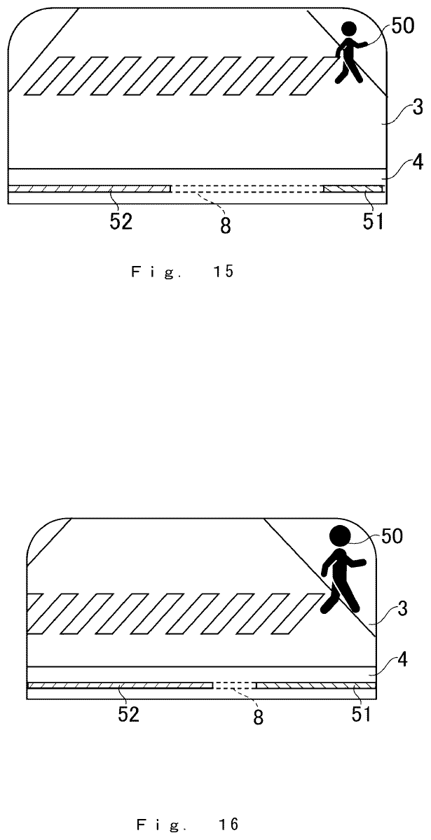

The display controller 30 may also vary the mode of the warning indicator 51 according to the traveling direction of the warning object 50. FIGS. 14 to 16 are diagrams illustrating time transition of the warning indicator 51 in a case where the traveling direction of the warning object 50 changes.

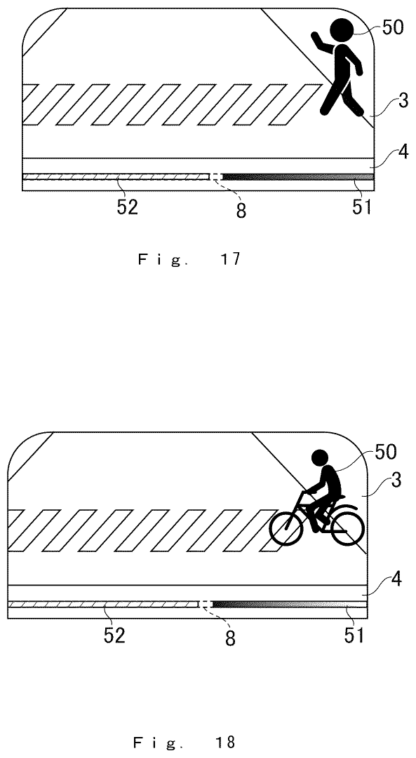

When detecting the warning object 50 crossing in front of the vehicle 1 as shown in FIG. 14, the display controller 30 displays the warning indicator 51 in a warning color such as red. On the other hand, when the warning object 50 stops crossing in front of the vehicle 1 and changes the traveling direction as shown in FIG. 15, and thus the warning level decreases, the display controller 30 displays the warning indicator 51 in a color representing a lower warning level than red (for example, orange). In order to avoid misrecognition by the driver 2, the display controller 30 preferably displays the warning indicator 51 and the attention-grabbing indicator 52 in different colors. Furthermore, when the distance between the warning object 50 and the vehicle 1 decreases, the display controller 30 may display the warning indicator 51 as shown in FIG. 16 with a wider width than the width of the warning indicator 51 in FIG. 15. It should be noted that the display controller 30 may use other properties, such luminance, as well as the color of the warning indicator 51 to vary the mode according to the traveling direction of the warning object 50.

The above-described configuration allows the driver 2 to intuitively recognize the level of danger associated with the traveling direction of the warning object 50 based on the difference in the display mode including the color of the warning indicator 51.

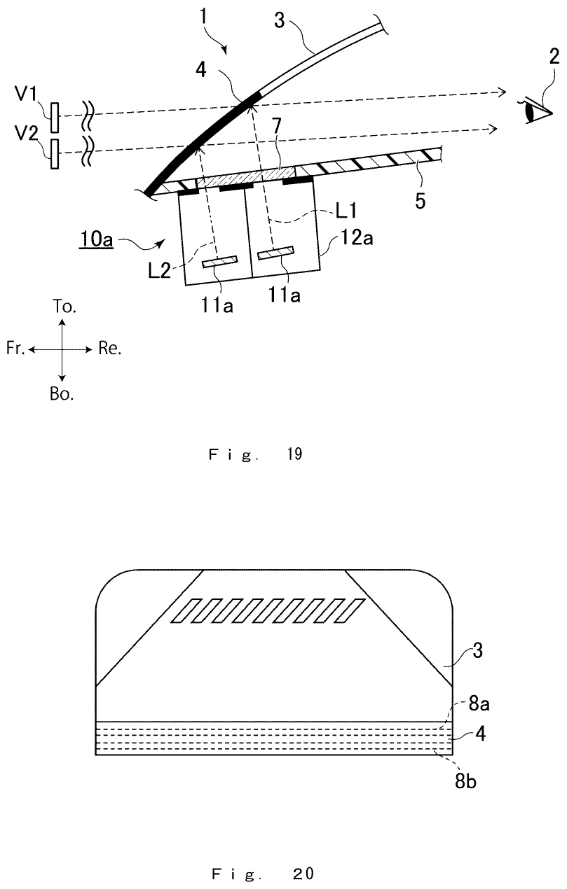

The display controller 30 may also vary the mode of the warning indicator 51 according to the speed of the warning object 50. FIGS. 17 and 18 are diagrams illustrating time transition of the warning indicator 51 in a case where the warning indicator 51 is displayed with a gradient. The display controller 30 varies the mode of the warning indicator 51 by using a higher rate of change in the gradient in a case where the warning object 50 is an object that moves at a higher speed such as a bicycle than in a case where the warning object 50 is an object that moves at a lower speed such as a pedestrian. For example, in the case where the warning object 50 is an object that moves at a lower speed, the display controller 30 displays the warning indicator 51 by forming a gradient in a density range of from 100% to 50% so that an end of the warning indicator 51 in the traveling direction is darker as shown in FIG. 17. On the other hand, in the case where the warning object 50 is an object that moves at a higher speed, the display controller displays the warning indicator 51 by forming a gradient in a density range of from 100% to 0% so that the end of the warning indicator 51 in the traveling direction is darker as shown in FIG. 18. It should be noted that the speed includes the absolute speed of the warning object 50, the relative speed of the warning object 50 to the vehicle 1, the acceleration of the warning object 50, and the like. The display controller 30 may use other properties, such as color or luminance, as well as the rate of change in the gradient of the warning indicator 51 to vary the mode according to the speed of the warning object 50. The gradient can be formed by adjusting the brightness levels in the display light L or adjusting the color density levels in the display light L.

The above-described configuration allows the driver 2 to intuitively recognize the speed of the warning object 50 based on the difference in the display mode including the difference in the rate of change in the gradient of the warning indicator 51.

In Step S3, the display controller 30 determines whether or not the driver 2 has recognized the warning object 50. For example, the display controller 30 determines whether or not the driver 2 has recognized the warning object 50 based on whether or not the gaze of the driver 2 is toward the warning object 50 by obtaining the result of the detection by the gaze sensor 41. The display controller 30 may determine whether or not the driver 2 has recognized the warning object 50 by obtaining, from the vehicle ECU 43, information as to whether or not the brakes have been applied. Upon determining that the driver 2 has not recognized the warning object 50 (NO in Step S3), the display controller returns the processing to Step S1 and repeats the processes in Step S1 and the following steps.

On the other hand, upon determining that the driver 2 has recognized the warning object 50 (YES in Step S3), the display controller 30 decreases the luminance of the warning indicator 51 and the attention-grabbing indicator 52 in Step S4. It should be noted that in Step S4, the display controller 30 may use other methods, such as changing the color to a less saturated color or decreasing the width of each indicator, since Step S4 is to just make the warning indicator 51 and the attention-grabbing indicator 52 less visible. Furthermore, it is sufficient that the display controller 30 makes at least one of the warning indicator 51 and the attention-grabbing indicator 52 less visible.

The above-described configuration allows the display controller to reduce the annoyance of the warning indicator 51 and the attention-grabbing indicator 52 staying visible even though the driver 2 has recognized the warning object 50. The above-described configuration also allows the display controller 30 to make the driver 2 intuitively recognize that the warning level has decreased.

Thereafter, the display controller 30 returns the processing to Step S1 and repeats the processes in Step S1 and the following steps.

The display device 10 described above notifies the driver 2 of the location of the warning object 50 by using the warning indicator 51 and draws the attention of the driver 2 to the warning indicator 51 by displaying the attention-grabbing indicator 52. This enables the display device 10 to appropriately convey information to the driver 2.

Although some embodiments of the present invention have been described, these embodiments are presented by way of example and are not intended to limit the scope of the invention. These novel embodiments can be implemented in various other forms, and various omissions, replacements, and changes can be made without departing from the gist of the invention. These embodiments and modifications thereof are included in the scope and gist of the invention, and are included in the invention described in the claims and the equivalents thereof.

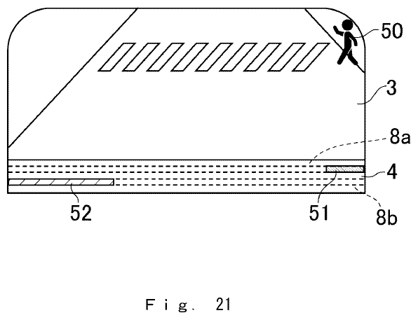

For example, the mode of the display device 10 according to the present embodiment is merely an example, and the present disclosure is not limited thereto. For example, FIG. 19 is a diagram illustrating a display device 10a, which is a display device according to another embodiment of the present disclosure. FIG. 20 is a diagram illustrating a display area 8a formed by the display device 10a. FIG. 21 is a diagram illustrating examples of a warning indicator 51 and an attention-grabbing indicator 52 displayed by the display device 10a.

The display device 10a differs from the display device 10 in that the display area 8 includes a first display area 8a and a second display area 8b. The first display area 8a and the second display area 8b are line-shaped (band-shaped) areas formed along an extending direction of the lower edge of the windshield 3 (predetermined direction) and arranged parallel to each other.

In order to form such display areas 8a and 8b, the display device 10a has LED units 11a including two LED rows that are arranged in a substantially front-rear direction and that each include LEDs arranged in the left-right direction. A housing 12a is divided into two spaces to accommodate the LED units 11a individually. The housing 12a also has two openings for emitting display light L1 and L2 independently. A display controller 30 (not shown in FIG. 19) displays, for example, a warning indicator 51 as a virtual image V1 in the upper first display area 8a and an attention-grabbing indicator 52 as a virtual image V2 in the lower second display area 8b.

The display device 10a having such a configuration can display the warning indicator 51 and the attention-grabbing indicator 52 in the respective display areas 8a and 8b, achieving an increase in the degree of freedom in the display mode.

The display device according to the present disclosure may use, as a display area, not only the light-shielding section 4 but also another portion of the windshield 3 that is located above the light-shielding section 4. The display device may display, for a viewer to see, not only the virtual image V but also a real image projected on, for example, a screen disposed in a desired position in the vehicle 1. In this case, the display device may be, for example, a liquid crystal display facing the viewer or another device formed inside the instrument panel and having a configuration that allows the viewer to directly see LED light emitted toward the viewer.

The display devices 10 and 10a have been described using examples in which the display areas 8, 8a, and 8b are straight in shape. However, the display areas are not limited to being straight and may be curved or zigzag.

### REFERENCE SIGNS LIST

1: Vehicle
2: Driver (viewer)
3: Windshield
4: Light-shielding section
5: Instrument panel
6: Opening
7: Protective cover
8: Display area
8a: First display area
8b: Second display area
10a: Display device
11, 11a: LED unit (display)
12, 12a: Housing
30: Display controller
41: Gaze sensor
42: External sensor
43: Vehicle ECU
45: CAN bus
50: Warning object
51: Warning indicator
52: Attention-grabbing indicator
L, L1, L2: Display light
V, V1, V2: Virtual image

1. A display device comprising:
a display that displays, in a display area, a warning indicator for notifying a viewer of a warning object located outside a vehicle and an attention-grabbing indicator for drawing attention of the viewer to the warning indicator; and
a display controller that controls and directs, upon detection of the warning object, the display to display the warning indicator in the display area at a warning position corresponding to the warning object and to display the attention-grabbing indicator in such a manner that the attention-grabbing indicator advances from a position other than the warning position toward the warning position.

2. The display device according to claim 1, wherein
the display area has a line shape along a predetermined direction, and
the display controller displays the attention-grabbing indicator in such a manner that the attention-grabbing indicator advances along the predetermined direction.

3. The display device according to claim 2, wherein
the display area includes a first display area and a second display area formed along the predetermined direction and arranged parallel to each other, and
the display controller displays the warning indicator in the first display area and the attention-grabbing indicator in the second display area.

4. The display device according to claim 2, wherein the display area is extending along a lower edge of a windshield of the vehicle.

5. The display device according to claim 1, wherein the display controller decreases a width of the warning indicator in a predetermined direction with an increase in distance between the vehicle and the warning object, and increases the width of the warning indicator in the predetermined direction with a decrease in the distance between the vehicle and the warning object.

6. The display device according to claim 1, wherein the display controller varies a display mode of the warning indicator according to a traveling direction of the warning object.

7. The display device according to claim 1, wherein the display controller varies a display mode of the warning indicator according to a speed of the warning object.

8. The display device according to claim 1, wherein the display controller makes at least one of the warning indicator and the attention-grabbing indicator less visible upon detection of the viewer recognizing the warning object.
